(19) United States
(12) Patent Application Publication
(10) Pub. No.: US 2025/0263105 A1
(43) Pub. Date: Aug. 21, 2025

(54) STEERING WHEEL

(71) Applicant: KABUSHIKI KAISHA TOKAI-RIKA-DENKI-SEISAKUSHO, Niwa-gun, Aichi-ken (JP)

(72) Inventor: Takahiro FUJII, Aichi (JP)

(21) Appl. No.: 18/857,769

(22) PCT Filed: Feb. 24, 2023
(86) PCT No.: PCT/JP2023/006856

§ 371 Date: Oct. 17, 2024

(30) Foreign Application Priority Data
Apr. 18, 2022 (JP) 2022-068522

(51) Int. Cl. B62D 1/11

(52) U.S. Cl. CPC B62D 1/11

(57) ABSTRACT

“A steering wheel is provided with a garnish at a rim portion. A narrow portion of the garnish is disposed at a deformation portion of the rim portion and has a decreased width dimension. Thus, even when the deformation portion undergoes bending deformation, the narrow portion can be deformed in conformity with the bending deformation of the deformation portion.”

### TECHNICAL FIELD

The present disclosure relates to a steering wheel at which decorative members decorate the grasped portion.

### BACKGROUND ART

In the steering wheel disclosed in Japanese Patent Application Laid-Open (JP-A) No. 2016-68758, anchoring claw portions, anchoring pieces, projections for positioning, rib portions and reinforcing ribs are provided at a decorative garnish. The height dimension of the decorative garnish (the dimension in the wall thickness direction thereof) varies, and, at a ring portion, the decorative garnish is mounted to a mounting base portion and a covering layer.

Here, at this steering wheel, if the ring portion is deformed at the time of a collision of the vehicle, it is preferable that the decorative garnish be able to deform so as to follow the deformation of the ring portion.

### SUMMARY OF INVENTION

### Technical Problem

In view of the above-described circumstances, an object of the present disclosure is to provide a steering wheel in which decorative members can deform so as to follow the deformation of a grasped portion.

### Solution to Problem

A steering wheel of a first aspect of the present disclosure includes: a grasped portion grasped by a passenger: a main body member provided at the grasped portion; and decorative members mounted to the main body member and decorating the grasped portion, and height dimensions, which are dimensions in wall thickness directions, of the decorative members vary, and wide portions, at which width dimensions that are dimensions circling around a length direction of the grasped portion are made to be large, and narrow portions, at which the width dimensions are made to be small, are provided at the decorative members.

In a steering wheel of a second aspect of the present disclosure, the steering wheel of the first aspect of the present disclosure includes engaging portions provided at the decorative members and engaged with the main body member.

In a steering wheel of a third aspect of the present disclosure, in the steering wheel of the second aspect of the present disclosure, the engaging portions are not provided at the narrow portions.

In a steering wheel of a fourth aspect of the present disclosure, in the steering wheel of the second aspect of the present disclosure, the engaging portions that are provided at the narrow portions have lower strength than the engaging portions that are provided at the wide portions.

In a steering wheel of a fifth aspect of the present disclosure, in the steering wheel of any one of the second aspect through the fourth aspect of the present disclosure, the engaging portions are fixing portions that are fixed to the main body member.

In a steering wheel of a sixth aspect of the present disclosure, the steering wheel of the fifth aspect of the present disclosure includes connecting portions that are provided at the decorative members, and that are electrically connected to a vehicle body side, and at whose peripheries the fixing portions are disposed.

In a steering wheel of a seventh aspect of the present disclosure, in the steering wheel of any one of the second aspect through the sixth aspect of the present disclosure, the engaging portions are latching portions that latch onto the main body member and that limit displacement of the decorative members with respect to the main body member.

In a steering wheel of an eighth aspect of the present disclosure, in the steering wheel of any one of the second aspect through the seventh aspect of the present disclosure, the engaging portions are disposed so as to not be orthogonal to the length direction of the grasped portion. Therefore, displacement of the decorative members with respect to the main body member can be limited.

### Advantageous Effects of Invention

In the steering wheel of the first aspect of the present disclosure, the main body member is provided at the grasped portion that is grasped by a passenger. The decorative members are mounted to the main body member and decorate the grasped portion. Further, the height dimensions (the dimensions in the wall thickness directions) of the decorative members vary.

Here, wide portions and narrow portions are provided at the decorative members. The width dimensions (the dimensions circling around the length direction of the grasped portion) of the wide portions are made to be large, and the width dimensions of the narrow portions are made to be small. Therefore, the narrow portions of the decorative members can deform following the deformation of the grasped portion.

In the steering wheel of the second aspect of the present disclosure, the engaging portions of the decorative members are engaged with the main body member. Therefore, the decorative members can engage with the main body member.

In the steering wheel of the third aspect of the present disclosure, the engaging portions are not provided at the narrow portions. Therefore, the narrow portions can deform well following the deformation of the grasped portion.

In the steering wheel of the fourth aspect of the present disclosure, the strength of the engaging portions of the narrow portions is made to be lower than the strength of the engaging portions of the wide portions. Therefore, the engaging portions of the narrow portions impeding deformation of the narrow portions can be suppressed, and the engaging portions of the narrow portions can suppress breakage due to deformation of the narrow portions.

In the steering wheel of the fifth aspect of the present disclosure, the engaging portions are fixing portions, and the fixing portions are fixed to the main body member. Therefore, the decorative members can be fixed to the main body member by the fixing portions.

In the steering wheel of the sixth aspect of the present disclosure, the connecting portions of the decorative members are electrically connected to the vehicle body side. Here, the fixing portions are disposed at the peripheries of the connecting portions. Therefore, displacement of the connecting portions with respect to the main body member can be suppressed.

In the steering wheel of the seventh aspect of the present disclosure, the engaging portions are latching portions, and the latching portions latch onto the main body member, and displacement of the decorative members with respect to the main body member is limited. Therefore, displacement of the decorative members with respect to the main body member can be limited.

In the steering wheel of the eighth aspect of the present disclosure, the engaging portions are disposed so as to not be orthogonal to the length direction of the grasped portion. Therefore, the engaging portions can appropriately limit displacement of the decorative members in the radial direction of the grasped portion with respect to the main body member.

### BRIEF DESCRIPTION OF DRAWINGS

FIG. 1 is a front view that is seen from a vehicle rear side and illustrates a steering wheel relating to a first embodiment of the present disclosure.

FIG. 2A is a drawing illustrating a rim portion of the steering wheel relating to the first embodiment of the present disclosure, and is a cross-sectional view along line 2A-2A of FIG. 1.

FIG. 2B is a drawing illustrating the rim portion of the steering wheel relating to the first embodiment of the present disclosure, and is a cross-sectional view along line 2B-2B of FIG. 1.

FIG. 3 is a front view that is seen from the vehicle rear side and illustrates the rim portion of the steering wheel relating to the first embodiment of the present disclosure.

FIG. 4A is a drawing illustrating an engaging portion of a garnish at steering wheels relating to the first through a fourth embodiment of the present disclosure, and is a perspective view illustrating a fixing rib.

FIG. 4B is a drawing illustrating the engaging portion of the garnish at the steering wheels relating to the first through the fourth embodiment of the present disclosure, and is a cross-sectional view illustrating a positioning rib.

FIG. 4C is a drawing illustrating the engaging portion of the garnish at the steering wheels relating to the first through the fourth embodiment of the present disclosure, and is a cross-sectional view illustrating an urging rib.

FIG. 5 is a front view that is seen from the vehicle rear side and illustrates the rim portion of a steering wheel relating to a second embodiment of the present disclosure.

FIG. 6 is a front view that is seen from the vehicle rear side and illustrates the rim portion of a steering wheel relating to a third embodiment of the present disclosure.

FIG. 7 is a front view that is seen from the vehicle rear side and illustrates the rim portion of a steering wheel relating to the fourth embodiment of the present disclosure.

### DESCRIPTION OF EMBODIMENTS

### First Embodiment

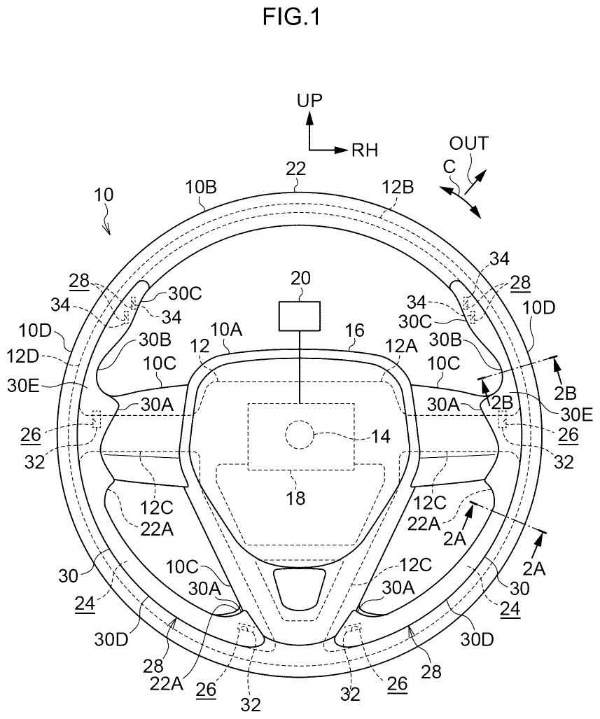

A steering wheel 10 that serves as a steering wheel relating to a first embodiment of the present disclosure is illustrated in FIG. 1 in a front view seen from a vehicle rear side. Note that, in the drawings, the vehicle front side is indicated by arrow FR, the vehicle right side is indicated by arrow RH, and the upper side is indicated by arrow UP. Moreover, the peripheral direction of the steering wheel 10 is indicated by arrow C, and the radial direction outer side of the steering wheel 10 is indicated by arrow OUT.

The steering wheel 10 relating to the present embodiment faces the driver's seat of the vehicle at the vehicle rear side. The steering wheel 10 is disposed at the vehicle front side of the passenger (the driver, the contacting person) seated in the driver's seat.

As illustrated in FIG. 1. a boss portion 10A serving as a supported portion is provided at the central portion of the steering wheel 10. A rim portion 10B, which is annular as seen in a front view and serves as a grasped portion, is provided at the outer peripheral portion of the steering wheel 10. Three spoke portions 10C serving as connecting portions are provided between the boss portion 10A and the rim portion 10B. The spoke portions 10C extend out from the boss portion 10A toward the vehicle left side, the vehicle right side and the lower side, and are connected to the rim portion 10B.

A metal core 12 that is made of metal and serves as a frame member is provided at the steering wheel 10.

A boss metal core 12A that is plate-shaped is provided at the central portion of the metal core 12, and the boss metal core 12A structures the boss portion 10A. The boss metal core 12A is fixed to the vehicle rear side end (the upper side end) of a steering shaft 14 that is solid cylindrical and serves as a supporting portion at the vehicle. The steering shaft 14 is disposed coaxially with the rim portion 10B. The steering wheel 10 (the metal core 12) is supported so as to be able to rotate integrally with the steering shaft 14. Due to the passenger grasping the rim portion 10B and rotatingly operating the steering wheel 10 in the peripheral direction, the steering shaft 14 is rotated around the central axis, and the vehicle is steered.

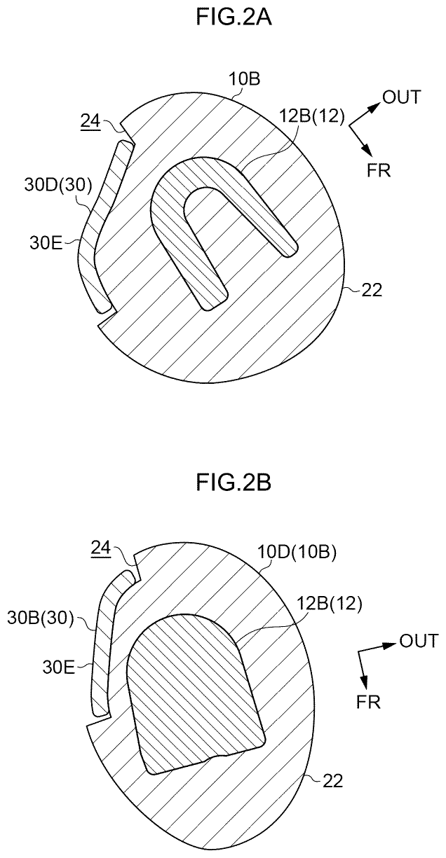

A rim metal core 12B (refer to FIGS. 2(A) and (B)) that is annular as seen in a front view is provided at the outer peripheral portion of the metal core 12, and the rim metal core 12B structures the rim portion 10B. Three plate-shaped spoke metal cores 12C are provided between the boss metal core 12A and the rim metal core 12B. The spoke metal cores 12C extend out from the boss metal core 12A toward the vehicle left side, the vehicle right side and the lower side (the radial direction outer side of the steering wheel 10), and are connected to the rim metal core 12B and structure the spoke portions 10C.

A pad 16, which is substantially box-shaped and is made of resin and serves as an accommodating member, is provided at the boss portion 10A and the spoke portions 10C. The interior of the pad 16 opens toward the vehicle front side. The pad 16 is attached to the vehicle rear sides of the boss metal core 12A and the spoke metal cores 12C. The pad 16 covers the vehicle rear sides of the boss metal core 12A and portions of the spoke metal cores 12C other than the portions thereof that are in vicinities of the rim portion 10B.

An airbag device 18 is accommodated within the pad 16. A bag-shaped airbag (not illustrated is provided within the airbag device 18 in a folded-up state. The airbag device 18 is electrically connected to a control device 20 (vehicle body side) of the vehicle.

A portion of the rim portion 10B that is in the vicinity of the upper side of the spoke portion 10C at the vehicle left side, and a portion of the rim portion 10B that is in the vicinity of the upper side of the spoke portion 10C at the vehicle right side, are made to be deformation portions 10D.

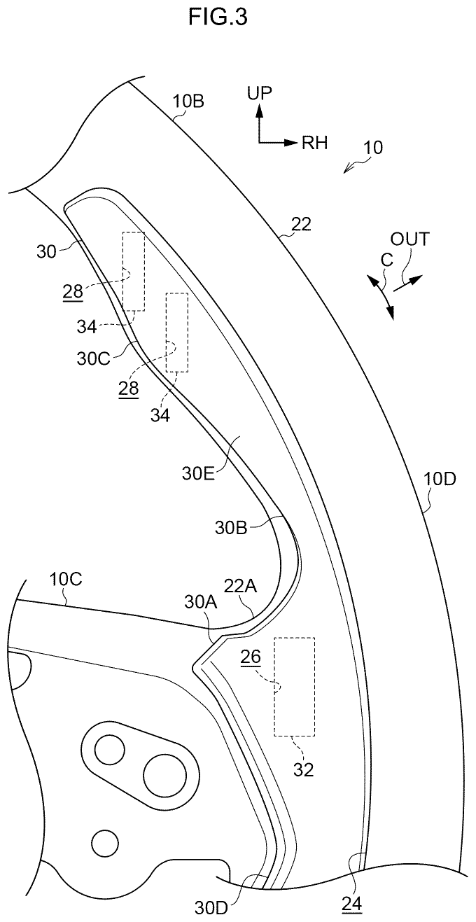

A main body member 22 (refer to FIG. 2A, FIG. 2B and FIG. 3) that is annular as seen in front view is provided along the entire length direction (the peripheral direction of the steering wheel 10) and peripheral direction (the direction of circling around the length direction) of the rim portion 10B. The main body member 22 is formed of a soft resin (e.g., is formed of polyurethane) and is elastic. The rim metal core 12B is accommodated within the main body member 22, and the main body member 22 is fixed to the rim metal core 12B. The outer shape, in a cross-section orthogonal to the length direction, of the main body member 22 is substantially circular, and the main body member 22 structures the peripheral surface of the rim portion 10B.

Projecting pillars 22A, which are substantially shaped as rectangular pillars, are formed integrally with the vehicle left side end portion, the vehicle right side end portion and the lower end portion of the main body member 22. The projecting pillars 22A project out toward the radial direction inner side of the steering wheel 10. Portions, which are in vicinities of the rim metal core 12B, of the spoke metal cores 12C are accommodated within the projecting pillars 22A, and the projecting pillars 22A are fixed to the spoke metal cores 12C.

Fixing recesses 24 are formed at the vehicle left side and the vehicle right side of the main body member 22, except for at the upper portion and the lower end portion of the main body member 22. The fixing recesses 24 are disposed at the vehicle rear side of the main body member 22, at portions that are at the radial direction inner side of the steering wheel 10. The fixing recesses 24 extend in the length direction of the rim portion 10B. The length directions of the fixing recesses 24 run along the length direction of the rim portion 10B, and the width directions of the fixing recesses 24 run along the peripheral direction of the rim portion 10B.

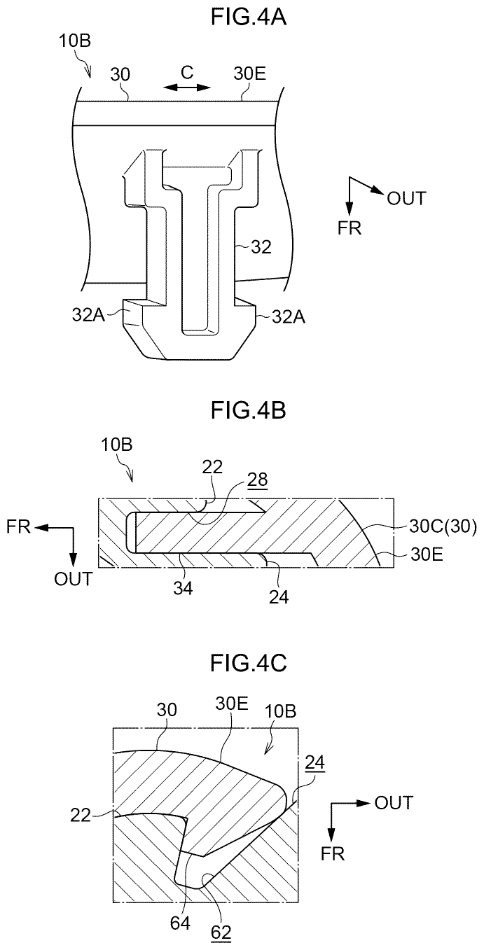

Fixing holes 26, which are rectangular and serve as engaged portions (fixed portions or latched portions), are formed in the bottom portions of the fixing recesses 24, at the upper side portions and the lower end portions of the vertical direction intermediate portions thereof. The fixing holes 26 are disposed substantially parallel to the length direction of the rim portion 10B, and open toward the vehicle rear side. Pairs of positioning holes 28 (refer to FIG. 4B), which are rectangular and serve as engaged portions (latched portions), are formed in the bottom portions of the fixing recesses 24 at the upper side portions of the upper portions thereof, and the positioning holes 28 open toward the vehicle rear side. The positioning holes 28 are elongated in the vertical direction (are not orthogonal and are not parallel to the length direction of the rim portion 10B). The pair of the positioning holes 28 are apart from one another in the vehicle left-right direction, and the vertical direction positions thereof are offset from one another.

Garnishes 30 (refer to FIG. 2A, FIG. 2B and FIG. 3), which are substantially shaped as elongated plates and serve as decorative members, are disposed in the fixing recesses 24 of the main body member 22, and the garnishes 30 are substantially formed of resin. The garnishes 30 are curved in the length directions and the width directions. The length directions of the garnishes 30 are disposed along the length directions of the fixing recesses 24, and the width directions of the garnishes 30 are disposed along the width directions of the fixing recesses 24. The garnishes 30 are substantially fit together with the fixing recesses 24, and the garnishes 30 structure the rim portion 10B, and are disposed at the steering wheel radial direction inner side (the steering shaft 14 side) and the vehicle rear side of the rim portion 10B.

Plate-shaped projecting portions 30A are formed integrally with the lower end portions of and vicinities of the upper portions of the garnishes 30. The projecting portions 30A project out toward the radial direction inner side of the steering wheel 10, and are disposed at the vehicle rear sides of the projecting pillars 22A of the main body member 22.

The lower side portions of the upper portions of the garnishes 30 are made to be narrow portions 30B, and the narrow portions 30B are disposed at the deformation portions 10D of the rim portion 10B. The portions, which are further toward the upper sides and lower sides than the narrow portions 30B, of the garnishes 30 are made to be upper wide portions 30C and lower wide portions 30D which respectively serve as wide portions. The width dimensions (the dimensions in the peripheral direction of the rim portion 10B) of the narrow portions 30B are made to be smaller than those of the upper wide portions 30C and the lower wide portions 30D. Further, the width dimensions of the portions, at which the projecting portions 30A are disposed, of the lower wide portions 30D are enlarged due to the projecting portions 30A.

Fixing ribs 32 (refer to FIG. 4A), which are substantially shaped as rectangular pillars and serve as engaging portions (fixing portions and latching portions), are formed integrally with the upper portions and the lower portions (the portions where the projecting portions 30A are disposed) of the reverse side surfaces of the lower wide portions 30D. The fixing ribs 32 are disposed at the width direction intermediate portions of the lower wide portions 30D. The fixing ribs 32 project out toward the vehicle front side and make the height dimensions (the dimensions in the wall thickness direction) of the lower wide portions 30D larger. The fixing ribs 32 are disposed substantially parallel to the length direction of the rim portion 10B. Anchor portions 32A shaped as trapezoidal pillars are formed integrally with the width direction both sides of the distal end portions of the fixing ribs 32. The anchor portions 32A project out toward the width direction outer sides of the fixing ribs 32. The surfaces, which are at the fixing rib 32 proximal end sides, of the anchor portions 32A are disposed orthogonal to the projecting directions of the fixing ribs 32. The garnishes 30 are mounted to the main body member 22 due to the fixing ribs 32 being press-fit into the fixing holes 26 of the main body member 22 (the fixing recesses 24), and the anchor portions 32A anchoring on the inner surfaces of the fixing holes 26, and the fixing ribs 32 being fixed in the fixing holes 26. Displacement of the fixing ribs 32 in the steering wheel 10 radial direction is limited by the fixing holes 26, and due thereto, displacement of the lower wide portions 30D in the steering wheel 10 radial direction is limited.

Pairs of positioning ribs 34 (refer to FIG. 4B), which are shaped as rectangular pillars and serve as engaging portions (latching portions), are formed integrally with the reverse side surfaces of the upper wide portions 30C. The positioning ribs 34 project out toward the vehicle front side and make the height dimensions (the dimensions in the wall thickness directions) of the upper wide portions 30C larger. The width directions of the positioning ribs 34 are the vertical direction (are not orthogonal to and not parallel to the length direction of the rim portion 10B). The pair of the positioning ribs 34 are apart from one another in the vehicle left-right direction, and the vertical direction positions thereof are offset from one another. The positioning ribs 34 are fit into the positioning holes 28 of the main body member 22 (the fixing recesses 24). Displacement of the positioning ribs 34 in the steering wheel 10 radial direction is limited by the positioning holes 28, and displacement of the upper wide portions 30C in the steering wheel 10 radial direction is limited.

The obverse surfaces of the garnishes 30 (including the projecting portions 30A) are structured by decorative layers 30E serving as decorative portions. A wood-grain pattern for example is formed at the decorative layers 30E, and the decorative layers 30E decorate the steering wheel 10.

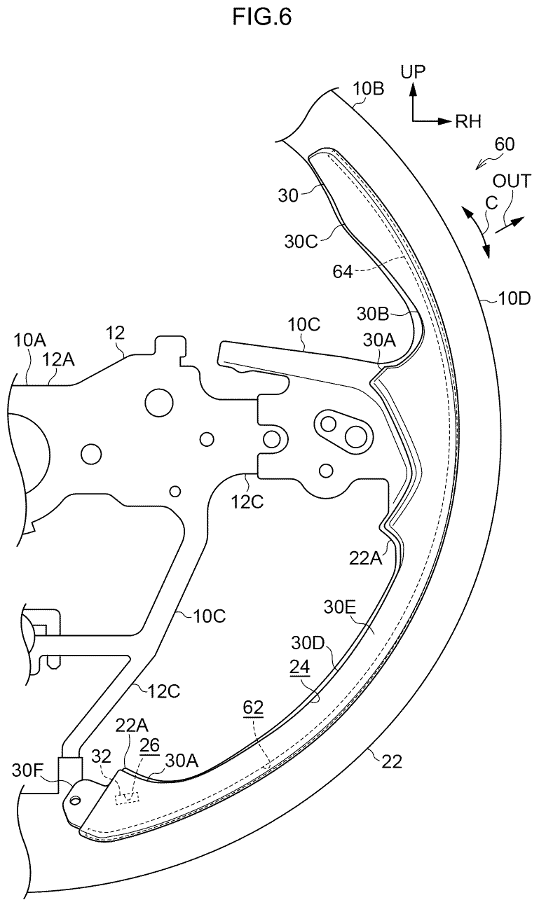

Electrode layers (not illustrated) serving as detecting portions are formed at the garnishes 30 (including the projecting portions 30A), at the reverse sides of the decorative layers 30E. The electrode layers are made of metal or are made of a conductive resin, and are electrically conductive. The electrode layers detect the electrostatic capacity between the electrode layers and the hands of the passenger that contact the garnishes 30 (including the projecting portions 30A), and can detect the contact of the hands of the passenger with the garnishes 30) (including the projecting portions 30A). Plate-shaped connecting portions 30F (refer to FIG. 6) are formed integrally with the lower ends of the garnishes 30. The connecting portions 30F are electrically connected to the electrode layers, are electrically connected to the control device 20, and electrically connect the electrode layers to the control device 20. On the basis of the fact that the electrostatic capacity between the hands of the passenger and the electrode layers is a predetermined electrostatic capacity or more, the control device 20 senses the grasping of the rim portion 10B by the passenger.

Operation of the present embodiment is described next.

In the steering wheel 10 of the above-described structure, at the rim portion 10B, the fixing ribs 32 of the lower wide portions 30D of the garnishes 30 are press-fit in the fixing holes 26 of the fixing recesses 24 of the main body member 22, and the positioning ribs 34 of the upper wide portions 30C of the garnishes 30 are fit in the positioning holes 28 of the fixing recesses 24 of the main body member 22. Therefore, even in cases in which the garnishes 30 deform in the radial direction of the steering wheel 10 due to post-molding shrinkage or the environment in which the steering wheel 10 is set, displacement of the garnishes 30 in the steering wheel 10 radial direction with respect to the main body member 22 can be limited by the fixing ribs 32 and the fixing holes 26 and by the positioning ribs 34 and the positioning holes 28, and the formation of gaps between the garnishes 30 and the inner surfaces of the fixing recesses 24 can be suppressed.

Moreover, the fixing ribs 32 and the fixing holes 26, and the positioning ribs 34 and the positioning holes 28, are disposed so as to not be orthogonal to the length direction of the rim portion 10B. Therefore, the fixing ribs 32 and the fixing holes 26, and the positioning ribs 34 and the positioning holes 28, can appropriately limit displacement of the garnishes 30 in the steering wheel 10 radial direction with respect to the main body member 22.

Further, the fixing ribs 32 at the lower sides of the garnishes 30 are fixed to the fixing holes 26 at the lower side of the main body member 22, and the connecting portions 30F of the garnishes 30 are electrically connected to the control device 20, and the connecting portions 30F are disposed at the peripheries of these fixing ribs 32 and fixing holes 26. Therefore, displacement of the connecting portions 30F with respect to the main body member 22 can be suppressed by these fixing ribs 32 and fixing holes 26, and cancelling of the electrical connection of the connecting portions 30F with the control device 20 can be suppressed.

By the way, at the time of a collision of the vehicle, high-pressure gas is instantaneously supplied into the airbag of the airbag device 18 by control of the control device 20, and the airbag is inflated. Due thereto, the airbag ruptures the pad 16 and is expanded at the entire vehicle rear side of the steering wheel 10. Due thereto, even if the head of the passenger hits the airbag, the kinetic energy of the head of the passenger is absorbed by the airbag, and impact to the head of the passenger is mitigated.

Moreover, due to the head of the passenger hitting the airbag, the rim portion 10B is bendingly deformed at the deformation portions 10D, and the portion, which is further toward the upper side than the deformation portions 10D, of the rim portion 10B tilts. Due thereto, the kinetic energy of the head of the passenger is absorbed also by the bending deformation of the rim portion 10B, and impact to the head of the passenger is effectively mitigated.

Here, the narrow portions 30B of the garnishes 30 are disposed at the deformation portions 10D of the rim portion 10B. The width dimensions of the narrow portions 30B are made to be small, and the section moduli (the strengths) of the narrow portions 30B are made to be small. Therefore, at the time of a collision of the vehicle, even if the deformation portions 10D are bendingly deformed, the narrow portions 30B can deform following the bending deformation of the deformation portions 10D.

Moreover, the fixing ribs 32 and the positioning ribs 34 are not provided at the narrow portions 30B. Therefore, the section moduli of the narrow portions 30B can still be made to be small, and the narrow portions 30B can be deformed well following the bending deformation of the deformation portions 10D.

Further, the positioning ribs 34 are provided at the upper wide portions 30C of the garnishes 30, and the positioning ribs 34 are not fixed to the positioning holes 28 of the main body member 22 and can move along the positioning holes 28. Therefore, at the time when the deformation portions 10D are bendingly deformed, even though the fixing ribs 32 of the lower wide portions 30D of the garnishes 30 at the lower sides of the narrow portions 30B are fixed to the fixing holes 26 of the main body member 22, the section moduli of the upper wide portions 30C can be made to be large by the positioning ribs 34, and the positioning ribs 34 can move along the positioning holes 28, and breakage of the upper wide portions 30C can be suppressed.

Moreover, the fixing ribs 32 of the garnishes 30 are fixed to the fixing holes 26 of the main body member 22. Therefore, at the time when the deformation portions 10D are bendingly deformed, the garnishes 30 coming apart from the main body member 22 can be suppressed.

### Second Embodiment

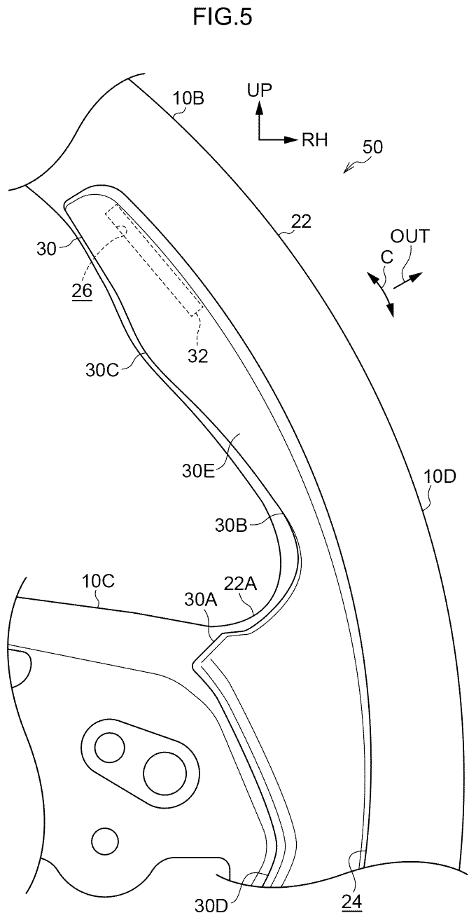

The rim portion 10B of a steering wheel 50, which serves as a steering wheel relating to a second embodiment of the present disclosure, is illustrated in FIG. 5 in a front view seen from the vehicle rear side.

The steering wheel 50 relating to the present embodiment is a structure that is substantially similar to the above-described first embodiment, but differs with regard to the following points.

As illustrated in FIG. 5, at the rim portion 10B of the steering wheel 50 relating to the present embodiment, instead of the positioning holes 28, the fixing holes 26 are formed in the bottom portions of the fixing recesses 24 of the main body member 22 at the upper side portions of the upper portions thereof. The fixing holes 26 are disposed substantially parallel to the length direction of the rim portion 10B and open toward the vehicle rear side. Further, the fixing holes 26 are not provided in the bottom portions of the fixing recesses 24 at the upper side portions of the vertical direction intermediate portions thereof.

Instead of the positioning ribs 34, the fixing ribs 32 are formed integrally with the reverse side surfaces of the upper wide portions 30C of the garnishes 30. The fixing ribs 32 are disposed at the steering wheel 50 radial direction outer side end portions of the upper wide portions 30C. The fixing ribs 32 project out toward the vehicle front side and make the height dimensions (the dimensions in the wall thickness directions) of the upper wide portions 30C larger. The fixing ribs 32 are disposed substantially parallel to the length direction of the rim portion 10B. The fixing ribs 32 are press-fit into the fixing holes 26 that are at the upper portions of the fixing recesses 24 of the main body member 22. The anchor portions 32A of the fixing ribs 32 anchor on the inner surfaces of the fixing holes 26, and the fixing ribs 32 are fixed to the fixing holes 26. Further, the fixing ribs 32 are not provided at the reverse side surfaces of the lower wide portions 30D at the upper portions thereof.

Here, in the present embodiment as well, operation and effects that are similar to those of the above-described first embodiment can be exhibited.

In particular, at the rim portion 10B, the fixing ribs 32 of the upper wide portions 30C and the lower wide portions 30D of the garnishes 30 are respectively press-fit into the fixing holes 26 of the fixing recesses 24 of the main body member 22. Therefore, even in cases in which the garnishes 30 deform in the radial direction of the steering wheel 10 due to post-molding shrinkage or the environment in which the steering wheel 10 is set, displacement of the garnishes 30 in the steering wheel 10 radial direction with respect to the main body member 22 can be limited by the fixing ribs 32 and the fixing holes 26, and the formation of gaps between the garnishes 30 and the inner surfaces of the fixing recesses 24 can be suppressed.

Moreover, the fixing ribs 32 and the fixing holes 26 are disposed so as to not be orthogonal to the length direction of the rim portion 10B. Therefore, the fixing ribs 32 and the fixing holes 26 can appropriately limit displacement of the garnishes 30 in the steering wheel 10 radial direction with respect to the main body member 22.

Further, the upper portions of the lower wide portions 30D of the garnishes 30 are not fixed to the main body member 22. Therefore, at the time of a collision of the vehicle, when the deformation portions 10D of the rim portion 10B are bendingly deformed, even though the fixing ribs 32 of the upper wide portions 30C of the garnishes 30 at the upper sides of the narrow portions 30B are fixed to the fixing holes 26 of the main body member 22, the width dimensions of the upper portions of the lower wide portions 30D can be made to be large, and the section moduli thereof can be made large, and the upper portions of the lower wide portions 30D can move, and breakage of the upper portions of the lower wide portions 30D can be suppressed.

### Third Embodiment

The rim portion 10B of a steering wheel 60, which serves as a steering wheel relating to a third embodiment of the present disclosure, is illustrated in FIG. 6 in a front view seen from the vehicle rear side.

The steering wheel 60 relating to the present embodiment is a structure substantially similar to the above-described second embodiment, but differs with regard to the following points.

As illustrated in FIG. 6, at the rim portion 10B of the steering wheel 60 relating to the present embodiment, the fixing holes 26 are not provided in the bottom portions of the fixing recesses 24 of the main body member 22 at the upper side portions of the upper portions thereof. Urging holes 62 (refer to FIG. 4C), which are trapezoidal in cross-section and serve as engaged portions, are formed in the bottom portions of the fixing recesses 24. The urging holes 62 are disposed at the steering wheel 60 radial direction outer side end portions of the fixing recesses 24. The urging holes 62 are disposed along the length direction of the rim portion 10B over the entire length directions of the fixing recesses 24, and the urging holes 62 open toward the vehicle rear side.

The fixing ribs 32 are not provided at the reverse side surfaces of the upper wide portions 30C of the garnishes 30. Urging ribs 64 (refer to FIG. 4C), which are trapezoidal in cross-section and serve as engaging portions (latching portions), are formed integrally with the reverse side surfaces of the garnishes 30. The urging ribs 64 are disposed at the steering wheel 60 radial direction outer side end portions of the garnishes 30. The urging ribs 64 project out toward the vehicle front side and make the height dimensions (the dimensions in the wall thickness directions) of the garnishes 30 larger, and are disposed along the length direction of the rim portion 10B over the entire length directions of the garnishes 30. The amounts of projection of the urging ribs 64 at the positions of the narrow portions 30B of the garnishes 30 are small as compared with at the positions of the upper wide portions 30C and the lower wide portions 30D of the garnishes 30. The urging ribs 64 are fit together with the urging holes 62 of the main body member 22 (the fixing recesses 24). Displacement of the urging ribs 64 in the steering wheel 10 radial direction is limited by the urging holes 62, and displacement of the garnishes 30 in the steering wheel 10 radial direction is limited.

Here, in the present embodiment as well, operation and effects that are similar to those of the above-described first embodiment can be exhibited.

In particular, at the rim portion 10B, the fixing ribs 32 of the lower wide portions 30D of the garnishes 30 are press-fit into the fixing holes 26 of the fixing recesses 24 of the main body member 22, and the urging ribs 64 of the garnishes 30 are fit in the urging holes 62 of the fixing recesses 24 of the main body member 22. Therefore, even in cases in which the garnishes 30 deform in the radial direction of the steering wheel 10 due to post-molding shrinkage or the environment in which the steering wheel 10 is set, displacement of the garnishes 30 in the steering wheel 10 radial direction with respect to the main body member 22 can be limited by the fixing ribs 32 and the fixing holes 26 and by the urging ribs 64 and the urging holes 62, and the formation of gaps between the garnishes 30 and the inner surfaces of the fixing recesses 24 can be suppressed.

Moreover, the fixing ribs 32 and the fixing holes 26, and the urging ribs 64 and the urging holes 62. are disposed so as to not be orthogonal to the length direction of the rim portion 10B. Therefore, the fixing ribs 32 and the fixing holes 26, and the urging ribs 64 and the urging holes 62, can appropriately limit displacement of the garnishes 30 in the steering wheel 10 radial direction with respect to the main body member 22.

Further, the amounts of projection of the urging ribs 64 are made to be small at the positions of the narrow portions 30B of the garnishes 30. Therefore, the section moduli of the narrow portions 30B becoming large can be suppressed, and, at the time of a collision of the vehicle, even if the deformation portions 10D of the rim portion 10B are bendingly deformed, the narrow portions 30B can deform following the bending deformation of the deformation portions 10D. Moreover, the urging ribs 64 are provided at the narrow portions 30B, and the section moduli of the narrow portions 30B are increased. Therefore, at the time when the deformation portions 10D are bendingly deformed, breakage of the narrow portions 30B can be suppressed.

Moreover, the urging ribs 64 are provided at the garnishes 30, and the urging ribs 64 are not fixed to the urging holes 62 of the main body member 22 and can move with respect to the urging holes 62. Therefore, at the time when the deformation portions 10D are bendingly deformed, the section moduli of the garnishes 30 can be made larger by the urging ribs 64, and the urging ribs 64 can move with respect to the urging holes 62, and breakage of the garnishes 30 can be suppressed.

Note that, in the present embodiment, the amounts of projection of the urging ribs 64 are made to be smaller at the positions of the narrow portions 30B of the garnishes 30, as compared with at the positions of the upper wide portions 30C and the lower wide portions 30D of the garnishes 30. However, the amounts of projection of the urging ribs 64 at the positions of the narrow portions 30B of the garnishes 30 may be made to be the same as at the positions of the upper wide portions 30C and the lower wide portions 30D of the garnishes 30. In this case, the garnish 30 width direction dimensions of the urging ribs 64 may be made to be smaller at the positions of the narrow portions 30B of the garnishes 30 than at the positions of the upper wide portions 30C and the lower wide portions 30D of the garnishes 30, and the section moduli of the urging ribs 64 may be made to be smaller at the positions of the narrow portions 30B of the garnishes 30 than at the positions of the upper wide portions 30C and the lower wide portions 30D of the garnishes 30. Further, the products of the garnish 30 width direction dimensions and the amounts of projection of the urging ribs 64 may be made to be smaller at the positions of the narrow portions 30B of the garnishes 30 than at the positions of the upper wide portions 30C and the lower wide portions 30D of the garnishes 30.

Moreover, the urging holes 62 and the urging ribs 64 in the present embodiment may be provided in the above-described first embodiment.

### Fourth Embodiment

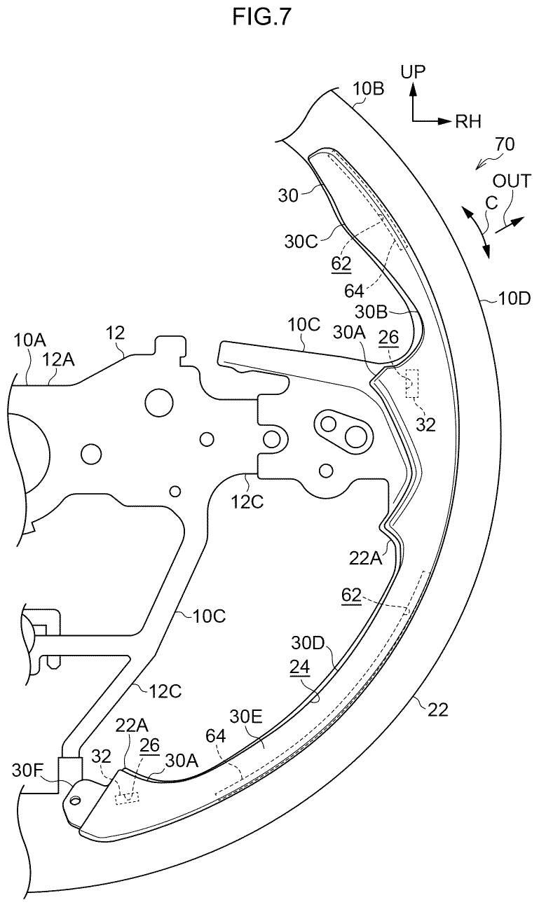

The rim portion 10B of a steering wheel 70, which serves as a steering wheel relating to a fourth embodiment of the present disclosure, is illustrated in FIG. 7 in a front view seen from the vehicle rear side.

The steering wheel 70 relating to the present embodiment is a structure that is substantially similar to the above-described third embodiment, but differs with regard to the following points.

As illustrated in FIG. 7, at the rim portion 10B of the steering wheel 70 relating to the present embodiment, the fixing holes 26 are formed in the bottom portions of the fixing recesses 24 of the main body member 22 at the upper side portions of the vertical direction intermediate portions thereof, in the same way as in the above-described first embodiment.

In the same way as in the above-described first embodiment, the fixing ribs 32 are formed integrally with the reverse side surfaces of the lower wide portions 30D of the garnishes 30 at the upper portions thereof. The fixing ribs 32 are press-fit into the fixing holes 26 of the main body member 22 (the fixing recesses 24), and the anchor portions 32A of the fixing ribs 32 anchor on the inner surfaces of the fixing holes 26, and the fixing ribs 32 are fixed to the fixing holes 26. Further, the urging ribs 64 are not provided at the upper portions and the lower end portions of the narrow portions 30B and the lower wide portions 30D of the garnishes 30.

Here, in the present embodiment as well, operation and effects that are similar to those of the above-described first embodiment can be exhibited.

In particular, at the rim portion 10B, the fixing ribs 32 of the lower wide portions 30D of the garnishes 30 are press-fit into the fixing holes 26 of the fixing recesses 24 of the main body member 22, and the urging ribs 64 of the garnishes 30 are fit into the urging holes 62 of the fixing recesses 24 of the main body member 22. Therefore, even in cases in which the garnishes 30 deform in the radial direction of the steering wheel 10 due to post-molding shrinkage or the environment in which the steering wheel 10 is set, displacement of the garnishes 30 in the steering wheel 10 radial direction with respect to the main body member 22 can be limited by the fixing ribs 32 and the fixing holes 26 and by the urging ribs 64 and the urging holes 62, and the formation of gaps between the garnishes 30 and the inner surfaces of the fixing recesses 24 can be suppressed.

Moreover, the fixing ribs 32 and the fixing holes 26, and the urging ribs 64 and the urging holes 62, are disposed so as to not be orthogonal to the length direction of the rim portion 10B. Therefore, the fixing ribs 32 and the fixing holes 26, and the urging ribs 64 and the urging holes 62, can appropriately limit displacement of the garnishes 30 in the steering wheel 10 radial direction with respect to the main body member 22.

Further, the fixing ribs 32 and the urging ribs 64 are not provided at the narrow portions 30B. Therefore, the section moduli of the narrow portions 30B can be made to be small, and, at the time when the deformation portions 10D are bendingly deformed, the narrow portions 30B can deform well following the bending deformation of the deformation portions 10D.

Moreover, the urging ribs 64 are provided at the upper wide portions 30C of the garnishes 30, and the urging ribs 64 are not fixed to the urging holes 62 of the main body member 22 and can move with respect to the urging holes 62. Therefore, at the time when the deformation portions 10D are bendingly deformed, even though the fixing ribs 32 of the lower wide portions 30D of the garnishes 30 at the lower sides of the narrow portions 30B are fixed to the fixing holes 26 of the main body member 22, the section moduli of the upper wide portions 30C can be made to be large by the urging ribs 64, and the urging ribs 64 can move with respect to the urging holes 62, and breakage of the upper wide portions 30C can be suppressed.

Note that, in the above-described first embodiment through fourth embodiment, the height dimensions of the garnishes 30 are made to be larger by the positioning ribs 34 and the urging ribs 64. However, the wall thickness dimensions of the garnishes 30 may be made to be larger, and the height dimensions of the garnishes 30 may be made to be larger.

Further, in the above-described first embodiment through fourth embodiment, the garnishes 30) are disposed at the steering wheel 10, 50, 60, 70 radial direction inner side of the rim portion 10B. However, together therewith, or in place thereof, the garnishes 30 may be disposed at the steering wheel 10, 50, 60, 70 radial direction outer side of the rim portion 10B.

Moreover, in the above-described first embodiment through fourth embodiment, the garnishes 30 are disposed at the vehicle rear side of the rim portion 10B. However, together therewith, or in place thereof, the garnishes 30 may be disposed at the vehicle front side of the rim portion 10B.

Further, in the above-described first embodiment through fourth embodiment, the rim portion 10B of the steering wheel 10 is annular as seen in a front view. However, the rim portion 10B of the steering wheel 10 may be a shape other than annular as seen in a front view. Moreover, the rim portion 10B of the steering wheel 10 may be divided into a vehicle left side portion and a vehicle right side portion. In this case, the steering wheel 10 may be formed in, for example, an H-shape as seen in a front view, without providing the lower side spoke portion 10C.

The disclosure of Japanese Patent Application No. 2022-068522 filed on Apr. 18, 2022 is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A steering wheel comprising:
a grasped portion configured to be grasped by a passenger;
a main body member provided at the grasped portion; and
decorative members mounted to the main body member and decorating the grasped portion, height dimensions, which are dimensions in wall thickness directions, of the decorative members varying, and the decorative members being provided with wide portions, at which width dimensions that are dimensions circling around a length direction of the grasped portion are larger than width dimensions of narrow portions.

2. The steering wheel of claim 1, comprising engaging portions provided at the decorative members and engaged with the main body member.

3. The steering wheel of claim 2, wherein the engaging portions are not provided at the narrow portions.

4. The steering wheel of claim 2, wherein the engaging portions that are provided at the narrow portions have lower strength than the engaging portions that are provided at the wide portions.

5. The steering wheel of claim 2, wherein the engaging portions are fixing portions, the fixing portions being fixed to the main body member.

6. The steering wheel of claim 5, comprising connecting portions, the connecting portions being provided at the decorative members, the connecting portions being electrically connected to a vehicle body side, and the fixing portions being disposed at peripheries of the connecting portions.

7. The steering wheel of claim 2, wherein the engaging portions are latching portions, the latching portions latching onto the main body member, and the latching portions limiting displacement of the decorative members with respect to the main body member.

8. The steering wheel of claim 2, wherein the engaging portions are disposed so as to not be orthogonal to the length direction of the grasped portion.
